(19) United States
(12) Patent Application Publication
(10) Pub. No.: US 2021/0080615 A1
(43) Pub. Date: Mar. 18, 2021

(54) METHOD AND SYSTEM FOR PREDICTING DAILY LIGHT INTEGRALS FOR CROP GROWING

(71) Applicant: Suntracker Technologies Ltd., Victoria (CA)

(72) Inventors: Jack Thomas, Victoria (CA); Ian Edward Ashdown, West Vancouver (CA)

(21) Appl. No.: 17/018,998

(22) Filed: Sep. 11, 2020

Related U.S. Application Data
(60) Provisional application No. 62/900,054, filed on Sep. 13, 2019.

(51) Int. Cl. G01W 1/12; G01J 1/02; A01G 7/04; B64G 1/10; A01G 9/24; G06N 3/08

(52) U.S. Cl. CPC G01W 1/12; G01J 1/02; A01G 7/045; B64G 2001/1042; A01G 9/249; G06N 3/08; B64G 1/1021

(57) ABSTRACT

Monthly average DLI values for a specified geographic location, or a greenhouse, polytunnel or other controlled environment at the specified geographic location, are calculated from historic reference data from weather stations. The calculations are a prediction based on the geographic similarity of the specified location to the locations of the weather stations. Calculations may also be based on the proximity of the weather stations. Weather data from satellites may also be used. A calculation indicates whether a proposed controlled environment in a specified geographic location will provide sufficient monthly DLI for a given crop with known DLI requirements. Where the DLI is insufficient, an amount of supplemental electric lighting is specified.

### TECHNICAL FIELD

The subject matter of the present invention relates to the field of horticultural lighting systems and more particularly, is concerned with the prediction of daily light integrals.

### BACKGROUND

The Daily Light Integral (DLI) is defined in ANSI/ASABE S640 JUL2017, Quantities and Units of Electromagnetic Radiation for Plants (Photosynthetic Organisms), as “photosynthetic photon flux density (PPFD) integrated over a 24-hour period, typically coinciding with the 24 hours of a calendar day.” This metric is useful in that it enables growers (horticulturalists, floriculturists, greenhouse operators, and farmers) to determine whether crops grown in an open field will receive sufficient photosynthetically active radiation (PAR) during the course of a growing season to grow to maturity.

The DLI metric can be calculated as monthly averages using historical weather data from selected weather stations as disclosed in Korczynski, P. et al. 2002. “Mapping Monthly Distribution of Daily Light Integrals Across the Contiguous United States,” HortTechnology 12(1):12-16. The authors calculated monthly average DLI values for 216 weather stations located in the continental United States, then used the weighted inverse distance between the six nearest neighbors to points on a regular grid to calculate an isocontour DLI plot of the continental United States for each month (FIG. 1).

A disadvantage of this method is that the isocontour DLI plots have very coarse resolution, and do not take into account local conditions that may result in considerably different monthly average DLI values for a specific geographic location.

The DLI metric can also be calculated as monthly averages using weather satellite imagery, daily snow cover data, and monthly averages of atmospheric water vapor, trace gases, and the amount of aerosols in the atmosphere (Perez, R. et al. 2002. “A New Operational Model for Satellite-Derived Irradiances: Description and Validation,” Solar Energy 73(5):307-317), as disclosed in Faust, J., and J. Logan. 2018. “Daily Light Integral: A Research Review and High-resolution Maps of the United States,” HortScience 53(9):1250-1257. Using this data, Faust and Logan (2018) calculated monthly average DLI values on a 100 km² regular grid for the 48 lower states and Hawaii, and on a 1600 km² grid for Alaska (FIG. 2).

A disadvantage of this method is that the necessary data for the model may not be readily available for regions outside of the United States.

In addition to field-grown crops, the DLI metric is applicable to crops grown in greenhouses. This includes many flowering plants for the florist trade, where the controlled environment and supplemental electric lighting can be used to extend the growing season and protect crops from inclement weather. However, there are no methods whereby the attenuation of direct sunlight and diffuse daylight by greenhouse glazing and shading materials can be calculated on an hourly basis. As a result, greenhouse operators can only assume an approximate reduction in DLI values of up to fifty percent of the outdoor DLI values.

The spatial distribution of DLI inside a greenhouse may also vary considerably, especially on clear days. The transmittance of direct sunlight through clear glazing varies with incidence angle (e.g., Ashdown, I. 2019. “Light Transmittance through Greenhouse Glazing,” Maximum Yield 21(3):50-51). For a greenhouse with, for example, a triangular cross-section (Venlo-style) roof and a roof slope of 25 degrees, the difference in direct solar irradiance on the greenhouse floor could be as much as 2:1.

Similarly, there are no methods that account for the attenuation of direct sunlight and diffuse daylight by agricultural films covering polytunnels (or “hoop houses”). Farmers can therefore only estimate the monthly DLI values received by their crops.

There is therefore a need to improve the DLI predictions based on historical weather data such as TMY3 (Typical meteorological year, third collection) weather files, and to accurately predict the attenuation of direct sunlight and diffuse daylight through greenhouse glazing and shading materials. Given such improved DLI predictions, greenhouse operators may determine the need for supplemental electric lighting on a monthly basis and so predict monthly electric energy requirements. They may also determine whether it is economically feasible to grow certain crops in their greenhouses. Similarly, farmers may use improved monthly average DLI predictions to determine whether certain crops will grow to maturity in their polytunnels.

### SUMMARY

Disclosed is a method for calculating a daily light integral in a specified geographic location comprising the steps of: specifying the latitude and longitude of a specified geographic location; identifying the nearest weather stations from a database that contains weather stations from anywhere on Earth for which historical weather data including direct normal and diffuse horizontal irradiance values are available; determining weather station data weights by taking into account local conditions for each weather station; calculating the hourly global horizontal irradiances from the weather station data; converting the irradiance values to PAR values; calculating the monthly average station DLI values; calculating the weighted monthly average DLI values; and displaying the results in a web application. Once the DLI values have been calculated, the method may include predicting the attenuation of direct sunlight and diffuse daylight through greenhouse glazing and shading materials for more accurate DLI values inside the greenhouse.

In another embodiment, a method is disclosed for calculating a daily light integral in a specific geographic location comprising the steps of: specifying the latitude and longitude of a specified geographic location; retrieving shortwave irradiance measurements by satellites which have worldwide coverage; calculating the hourly global horizontal irradiances from the satellite data; converting the irradiance values to PAR values; calculating the monthly average satellite DLI values; calculating the weighted monthly average DLI values; and displaying the results in a web application. Once the DLI values have been calculated, the method may include predicting the attenuation of direct sunlight and diffuse daylight through greenhouse glazing and shading materials for more accurate DLI values inside the greenhouse.

In another embodiment, a method is disclosed for calculating a daily light integral in a specific geographic location comprising the steps of the preceding two paragraphs, in other words combining historical weather data and satellite data.

Also disclosed is a method for determining whether a controlled environment in a specified geographic location will provide sufficient monthly DLI for a given crop comprising the steps of: specifying a desired crop with known DLI requirements; specifying the latitude and longitude of a specified geographic location; specifying the orientation of the controlled environment; specifying the controlled environment design parameters; identifying the nearest weather stations and/or using satellite data for which historical weather data including direct normal and diffuse horizontal irradiance values are available; determining weather station data weights and/or satellite data weights; calculating the hourly average direct normal irradiance, diffuse horizontal irradiance, and dew point temperature; specifying a virtual irradiance sensor array for the controlled environment; calculating the hourly global horizontal irradiance distribution inside the controlled environment as determined by the virtual irradiance sensors; converting the irradiance values to PAR values; calculating the monthly interior DLI distribution for the virtual sensor locations; comparing the calculated DLI values to the DLI requirements of the specified crop; and displaying the results.

A method for calculating a daily light integral (DLI) in a geographic location comprising the steps of: determining a value of a parameter of the geographic location; determining, for each of multiple weather stations, a further value for a corresponding parameter of a location of the weather station; calculating a geographic similarity of each of the multiple weather stations to the geographic location using the value and the further values; weighting DLI values for each of the multiple weather stations using the geographic similarities; calculating DLI values for the geographic location using the weighted DLI values; and displaying the calculated DLI values for the geographic location.

Also disclosed is a method for calculating a daily light integral (DLI) in a geographic location comprising the steps of: determining a value of a parameter of the geographic location; determining, for each of multiple weather stations, a further value for a corresponding parameter of a location of the weather station; calculating a geographic similarity of each of the multiple weather stations to the geographic location using the value and the further values; weighting DLI values for each of the multiple weather stations using the geographic similarities; calculating DLI values for the geographic location using the weighted DLI values; and displaying the calculated DLI values for the geographic location.

The disclosed and/or claimed subject matter is not limited by this summary as additional aspects are presented by the following written description and associated drawings.

### BRIEF DESCRIPTION OF DRAWINGS

FIG. 1 shows monthly average DLI isocontour plots for the continental United States. (Prior art from Korczynski et al. 2002).

FIG. 2 shows monthly average DLI isocontour plots with improved spatial resolution for the continental United States, Hawaii and Alaska. (Prior art from Faust and Logan 2018).

FIG. 3 shows a flowchart representing the main steps or calculating DLI, according to an embodiment of the present invention.

FIG. 4 shows an artificial neural network diagram for predicting geographic similarity, with input vectors described and the hidden layers shown, according to an embodiment of the present invention.

FIG. 5 shows a flowchart for a method of calculating the monthly average DLI values for a specified geographic location, then displaying them in a web application, according to an embodiment of the present invention.

FIG. 6 shows a monthly average DLI report prepared for a specified geographic location, according to an embodiment of the present invention.

FIG. 7 shows a flowchart for a method of calculating the monthly average DLI values for a specified geographic location, with satellite data incorporated, according to an embodiment of the present invention.

FIG. 8 shows a flowchart for a method of determining whether a greenhouse in a specified geographic location will provide sufficient monthly DLI for a given crop.

FIG. 9 shows a flowchart for a method of determining whether a greenhouse in a specified geographic location will provide sufficient monthly DLI for a given crop, with satellite data incorporated, according to an embodiment of the present invention.

FIG. 10 is a schematic block diagram of a system for predicting the DLI, according to an embodiment of the present invention.

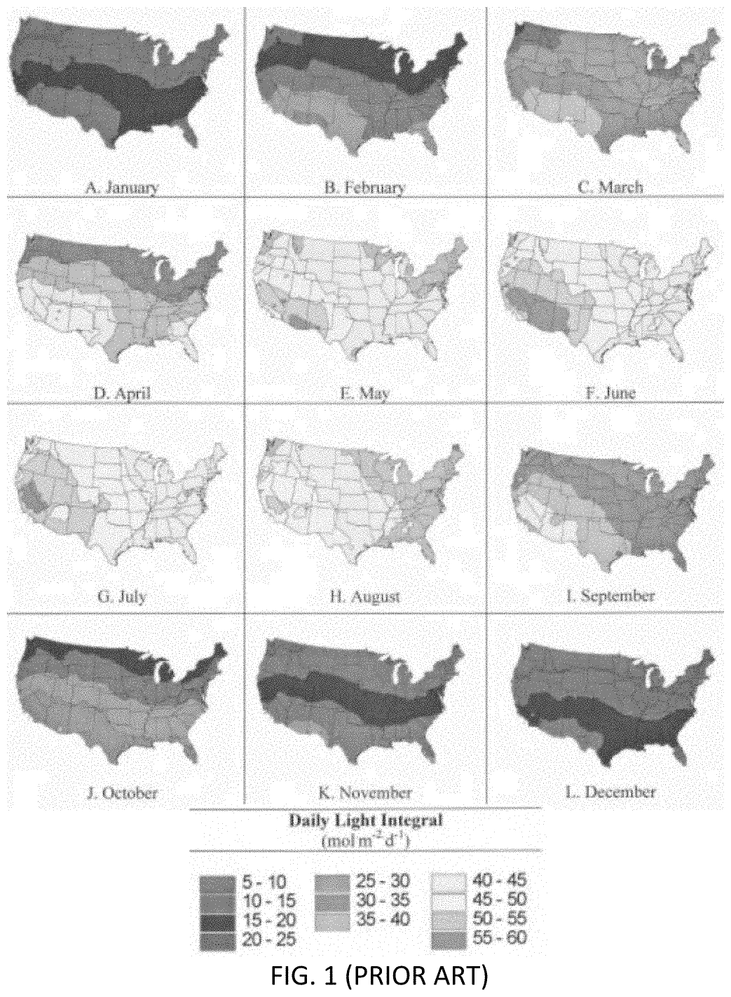

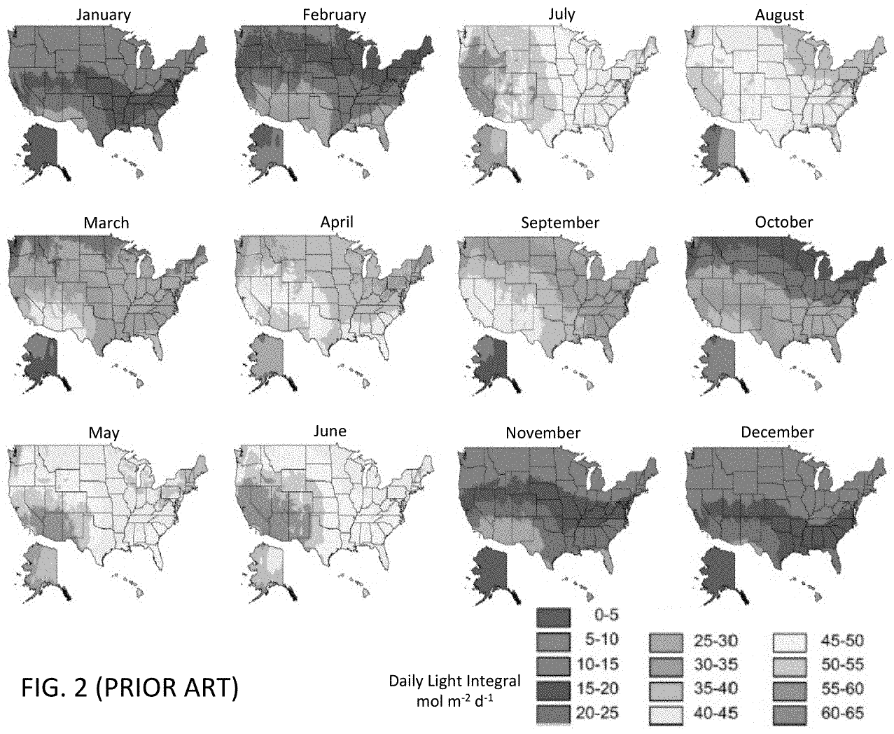

### DETAILED DESCRIPTION

The term “controlled environment” may include any area or structure within which crops may be grown that utilizes daylight for crop growth, with optional glazing materials, shading materials, agricultural films, and/or other means that may affect the daylight entering the controlled environment. Non-limiting examples of a controlled environment include greenhouses, polytunnels, or hybrid structures that may allow some daylight to enter the structure. Supplemental electric lighting may also be used to provide additional illumination to the crop in the controlled environment.

Web-based applications may include any application that can be accessed through a desktop computer, laptop computer, tablet, smartphone or any other device capable of accessing the internet.

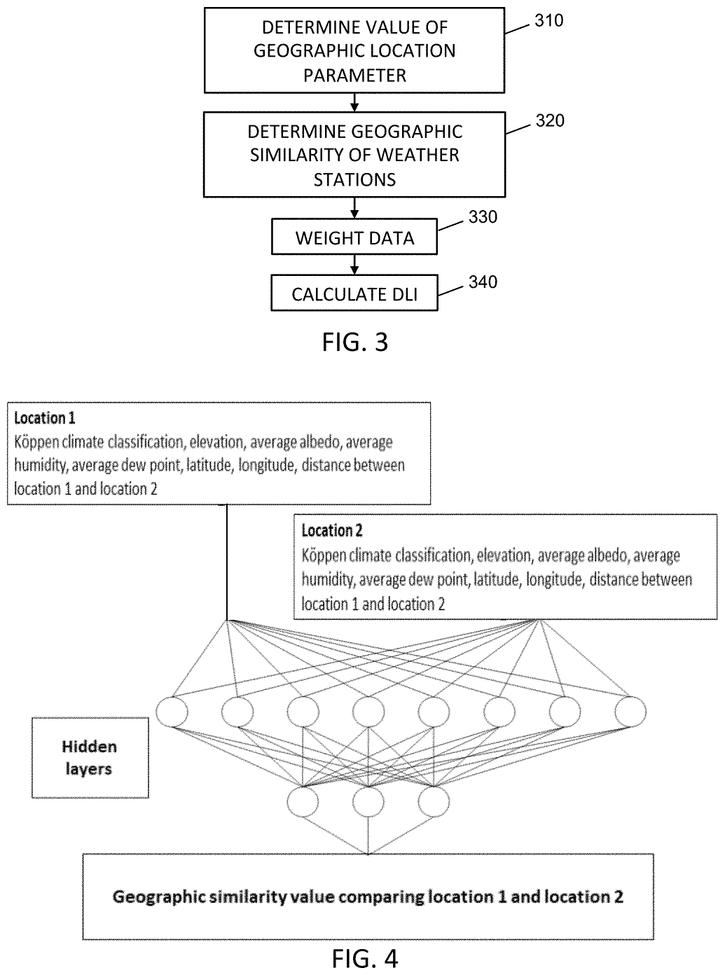

Referring to FIG. 3, an overview of the main steps of an exemplary method for predicting a DLI is shown. In step 310, one or more geographic features of a specified geographic location are determined, for example by measuring the value of a geographic parameter. This may involve, for example, determining the average temperature or precipitation of the specified geographic location. The parameters in this method include any metric that defines a geographic feature of the geographic location, except for specific values of longitude and latitude, which may be used separately when the location of the specific geographic location needs to be taken into account. In step 320, the weather stations from which data is to be retrieved have their locations analyzed for geographic similarity to the specified geographic location. These weather stations may be anywhere in the world or they may be the closest weather stations to the specified geographic location. In step 330, the data from the weather stations is weighted according to the geographic similarity of the weather stations to the specified location. In step 340, the DLI for the specified geographic location is calculated. The resulting DLI is therefore based on actual, remote measurements that are adjusted for how closely the locations of those measurements resemble the location for which the DLI is being predicted.

In some embodiments, the monthly average DLI values for field-grown crops at a specified geographic location are calculated based on historical weather data from selected weather stations as disclosed in Korczynski et al. (2002). There are over 2,300 weather stations worldwide for which TMY3 weather files (Wilcox, S., and W. Marion. 2008. User Manual for TMY3 Data Sets, National Renewable Energy Laboratory Technical Report NREL/TP-581-43156) are available. In the present invention, the great circle distance from each weather station to the specified geographic location is calculated as described in, for example, Ivis, F. 2006. “Calculating Geographic Distance: Concepts and Methods,” Proc. NESUG 2006, Sep. 17-20, Philadelphia, Pa. From this dataset, the closest three weather stations are selected.

In other embodiments, the three most geographically similar weather stations are selected from the dataset. The factors that determine geographical similarity are based on but not limited to station elevation, surrounding terrain (e.g., mountains and nearby water sources), urbanization and forest cover, average ground albedo, wind patterns, dew point temperature, atmospheric water vapor, latitude, ocean circulation patterns, long-term atmospheric circulation, lifezone classification, and atmospheric aerosols, as well as elevation. This allows the invention to select stations that are possibly distant from the specified geographic location.

Geographic similarity can then be defined as the similarity between two locations based on geographic factors and atmospheric factors as described above. A geographic similarity metric can be constructed that weighs all these geographic factors into a value between 0 and 1, where 1 is most similar and 0 is least similar, between two locations. The climate of a location is significantly impacted by the geography of a location, so finding similar climates means finding similar geographies.

The Köppen climate classification system can be used as part of a geographic similarity metric. The Köppen climate classification system (Köppen, W. 1884. “The thermal zones of the earth according to the duration of hot, moderate and cold periods and to the impact of heat on the organic world”. Meteorologische Zeitschrift: 351-360) is a widely used and well researched way of classifying climates. It uses temperature and precipitation patterns to divide climates into 5 main groups: A (tropical), B (dry), C (temperate), D (continental), and E (polar). It further subdivides these main groups based on seasonal precipitation and seasonal temperature. One embodiment of incorporating the Köppen climate system into the geographic similarity metric is described where C1 and C2 are climates for locations 1 and 2:
If C1 and C2 have the same main climate type, add 70% to the similarity measure
   a) If C1 and C2 each contain either a precipitation or a temperature subgroup but not both, add 30% if they match
   b) If C1 and C2 each contain both a precipitation and a temperature subgroup, add 15% for each matching subgroup The resulting similarity measure between Köppen climate classification groups will be set between 0 and 1, where 1 is the most similar and 0 is the least similar. The mean absolute percentage error (MAPE) will be used for all other geographic parameters (surface albedo, elevation, dew point, atmospheric water vapor amounts, atmospheric aerosol amounts, etc.). Indicators of nearby water sources or cities will be given truth values of 0 or 1. All MAPE values will be normalized between 0 and 1. All of these values will be averaged to produce the Geographic Similarity Metric. Now, we select stations based on their geographic similarity metrics. We calculate the geographic similarity metric for every station in the database with respect to the user location, and select the three stations with the highest similarities. This may result in DLI values that are more accurate for the user location compared to using the three closest weather stations without regard to geographic similarity.

In another embodiment, the Köppen-Geiger climate classification system (Geigar, R. 1954. “Classification of climates after W. Köppen.” Landolt-Börnstein-Zahlenwerte und Funktionen aus Physik, Chemie, Astronomie, Geophysik und Technik, alte Serie: 603-607) can be used as part of a geographic similarity metric. The Köppen-Geiger climate classification system is a modification of the Köppen climate classification system which has more than twice the number of classification types. It aims to be more modern than the Köppen climate classification system, and reflect the changing climate of our world.

In determining the geographic type of a location, it would be advantageous to determine what separates the geographic types from each other. Geographic dissimilarity would be the geographic factors that separate geographic types, and could be used to help train a neural network on the data.

The Holdridge Life Zones system (Holdridge, L. 1967. “Life zone ecology.” Fort Collins, Colo.: Tropical Science Center, San periment Station.) can also be used as a part of a geographic similarity metric. The Holdridge life zones system classifies land areas into various categories such as desert, desert scrub, steppe, moist forest, wet forest, rain forest, and more. The criteria for dividing the areas are: precipitation, temperature, evapotranspiration ratio, humidity, latitudinal regions, and altitudinal belts. Once a zone for a particular area has been determined, soil and climax vegetation can be mapped. We can incorporate Holdridge Life Zones in a similar manner to that described above for determining geographic similarity.

Environmental indicators such as the types of vegetation that grows optimally in a location can be used to classify that location's climate. Since each plant species requires a specific range of climate parameters, it follows that if a plant species thrives in multiple locations then those locations would share a similar climate. Biome names can be used in this case.

In an extension of this, the United States Department of Agriculture (USDA) Plant Hardiness Zones can determine which plants will be most likely to thrive in a location. Average annual minimum winter temperature is used to classify the zones. Again, it follows that if a plant species thrives in multiple locations then those locations would share a similar climate. Plant hardiness zones can be applied to a worldwide scope.

Another useful metric for classifying a location's climate is the degree-day (U.S. Energy Information Administration. (n.d.). “Units and calculators explained. Degree days”.). Degree-days are a metric describing how long (days) and how much (degrees) the outside air temperature was below a certain level. It follows that locations with similar degree-days may have similar climates.

The TMY3 weather records report hourly readings of direct normal irradiance (DNI) due to sunlight and diffuse horizontal irradiance (DHI) due to skylight, measured over the spectral range of 400 nm to 2700 nm and expressed in watts per square meter (averaged over the hourly period). The global horizontal irradiance (GHI) may be calculated by GHI=cos (θ)*DNI+DHI, where θ is the solar zenith angle at the time of the middle of the hourly period. As discussed in Faust and Logan, the PAR spectral range (400 nm to 700 nm) is 45 percent of the solar spectral range, and 4.48 micromoles per Joule is the conversion from radiometric to photon units. The conversion factor from average GHI to PAR integrated over the hourly period is thus 0.0072664 moles per watt-hour.

The solar zenithal angle may be determined by first determining the solar declination angle:

δ=0.4093 sin(2π(J−81)/365)

where δ is in radians and J is the Julian date.

The solar zenith angle θ in radians is then given by:

$$θ = \frac{π}{2} - ( sin ( l ) sin ( δ ) - cos ( l ) cos ( δ ) cos ( \frac{π t}{12} ) )$$

where l is the site latitude in radians, and t is the solar time in decimal hours.

The solar time t is given by:

$$t = {t}_{s} + ET + \frac{12 ( SM - L )}{π}$$

where tₛ is the standard time in decimal hours, SM is the standard meridian for the time zone in radians, L is the site longitude in radians, and ET is the Equation of Time, which is given by:

$$ET = 0.1644 sin ( \frac{4 π ( J - 81.6 )}{365.25} ) - 0.1273 sin ( \frac{2 π ( J - 2.5 )}{365.25} )$$

In another embodiment the solar zenithal angle may be determined by first determining the solar declination angle:

δ=0.396372−22.91327*cos(year fraction)+4.02543*sin(year fraction)0.387205*cos(2*year fraction)+0.051967*sin(2*year fraction)−0.154527*cos(3*year fraction)+0.084798*sin(3*year fraction)

Where year fraction is the part of the year in degrees:

$$year fraction = ( \frac{360}{365.25} ) * ( nthday + \frac{hour - UTCoffset}{24} )$$

where nthday is the n^{th} day of the year and UTCoffset is the offset from the Coordinated Universal Time, and where δ is in radians.

In another embodiment the solar zenith angle may be given by:

cos(Z)=sin(latitude)*sin(δ)+cos(latitude)*cos(δ)*cos(SHA)
where Z is the zenith angle in radians, SHA is the solar hour angle in radians, and δ is the declination angle in radians.

Solar Hour Angle:

SHA=((hour+UTCoffset−12)*15)+longitude+TC
where TC is Time Correction and SHA must be between −180 and 180 degrees.

TC=0.004297+0.107029*cos(year fraction)−1.837877*sin(year fraction)−0.837378*cos(2*year fraction)−2.340475*sin(2*year fraction)

Korczynski et al. (2002) calculated the monthly average DLI values for the six nearest weather stations, then weighted them by their inverse distances to the specified geographic location before interpolating the location monthly average DLI values. The six rather than three nearest weather stations were chosen in order to generate relatively smooth isocontour lines for the entire continental United States. In the present invention and as a non-limiting example, the three nearest weather stations are weighted using the transformation 1−F(xⱼ), where F(xⱼ) is the cumulative distribution function of the normal distribution with mean μ=average weather station distance and variance σ²=1000, and where xⱼ is the weather station distance. The three values are then normalized between 0 and 1. Compared to the weighting scheme of Korczynski et al. (2002), this weighting favors the closest weather station while still allowing contributions from the more distant stations. The DLI values are calculated according to:

$${DLI}_{i} = {\sum }_{j ∈ stations} ( {weight}_{j} ) * 0.0072664 * 24 * avg ( {GHI}_{ij} )$$

In another non-limiting example, the stations are weighted according to their geographic similarity. This uses the transformation 1−F(yⱼ), where F(yⱼ) is the cumulative distribution function of the normal distribution with mean μ=average geographic similarity and variance σ² is dependent on the chosen geographic similarity metric, and where yⱼ is the geographic similarity measure for station j.

For example, a specified location may be adjacent to a mountain range, whereas two of the three nearest weather stations are situated some distance from the mountain range. The prevailing winds further result in increased cloud cover near the mountain range. In this situation, the hourly global irradiance values for station nearest the mountain range will be more heavily weighted than weighting based on proximity alone, for the purposes of calculating DLI values. As another example, a more distant weather station with a significantly greater geographic similarity may have a greater weighting than a closer weather station with a lower geographic similarity.

In practice, assessing geographic similarity may be determined by a set of fuzzy logic heuristic rules, where the rules may be validated by comparing predicted monthly average DLI values for a set of geographic locations in the United States with the estimated monthly average DLI values as calculated by Faust and Logan (2018).

In another embodiment, the geographic similarity metrics are predicted using neural networks. An artificial neural network (ANN) can learn patterns based on data. Constructing an ANN that learns what makes two locations geographically similar may allow for a more theoretically sound approach to calculating geographic similarity metrics than comparison of geographic parameter values. The input to the neural network would be geographic parameters such as surface albedo, elevation, humidity, average dew point, latitude, longitude, the Köppen climate classification type of each location, and other parameters for two geographic locations. The output for the neural network is a crisp value between 0 and 1 where 1 is the most geographically similar, and 0 is the least geographically similar. Training the network may be done by calculating geographic similarity metrics using the methods described earlier of every weather station compared with n randomly chosen weather stations, then splitting the results into training and testing data. FIG. 4 shows a diagram of an artificial neural network that may be used.

In another embodiment, the geographic similarity metrics are predicted using Hidden Markov Models. Hidden Markov Models are statistical classifiers that have applications in reinforcement learning, speech recognition, and bioinformatics. Hidden Markov models use the Markov process, where unobservable states X determine some process Y. So, in this case the unobservable states are the geographic factors, and the geographic similarity metric is the process. We can train the data on these Hidden Markov Models to predict the geographic similarity metrics between locations, which we can then use to weight the stations.

In another embodiment, the geographic similarity metrics are predicted using Support Vector Machines. Support Vector Machines (SVMs) are supervised learning models that classify data and can also perform regression analysis. SVMs can separate data points and classify them, meaning we can classify geographic types for different locations. Then, we can calculate geographic similarity metrics from this classification. Finally, we can use those geographic similarity metrics to weight the stations.

In the most general sense, the geographic similarity metrics may be predicted using some pattern matching algorithm. The algorithm may find patterns that make locations more geographically similar to each other, then output a geographic similarity metric.

In yet another non-limiting example, the stations are weighted according both to their distance from the specified geographic location and to their geographic similarities to the specified location. The weighting of both satellite and ground station data may be employed when calculating DLI values.

In one embodiment, the average of the ground station data and satellite data are taken to produce DLI values. In another embodiment, ground station data is weighted according to its distance from the user location and then the average is taken between the ground station data and the satellite data. In another embodiment, ground station data is weighted according to its geographic similarity (where a higher geographic similarity metric is given more weight) to the user location, then the average is taken between the ground station data and the satellite data.

When we use satellite data in tandem with ground station data, a question arises: “How does satellite data compare to ground station data? How close are the satellite values compared to the ground station values?”. We can call the ground station dataset the ‘old’ dataset and the satellite dataset the ‘new’ dataset. We can compare datasets using statistical techniques. There are three possible outcomes for this investigation:
1. The datasets are statistically the same.
2. The datasets are statistically different, but the difference is not significant enough to affect the values.
3. The datasets are statistically different, and the difference is significant enough that we need to apply a correction to one dataset to make it closer to the other dataset.

A statistical correction may be to simply add the average difference between the old and the new dataset to the new dataset. To see if the datasets are statistically different, we can compute the differences between the two sets, check the normality assumption of the differences, look at the interquartile ranges of the differences, and finally calculate confidence intervals for the differences of the sets to see if that interval contains 0. If the confidence interval does not contain 0, there is strong evidence against the null hypothesis that the datasets are statistically the same.

In another embodiment, differences are calculated stratified by ranges. We define ranges for DLI values such as very low (<5), low (5-10), etc. and calculate the differences between the ground station data and the satellite data grouped by range. Then we perform statistical analysis described above to see if there are differences between the two datasets.

If the datasets are statistically different, we must decide whether the difference is significant enough to apply a correction to the data. Based on a cursory look at DLI charts and tables, we can estimate that 2 mol*m⁻²*d⁻¹ is an allowance for DLI precision. In other words, if the difference between the datasets is more than 2 mol*m⁻²*d⁻¹ on average, we should apply the correction.

Once we have reached some conclusion with respect to whether or not the datasets are the same and whether or not we need to apply a correction to the new dataset, we can proceed to use a new dataset in tandem with the old dataset to fill in gaps of information.

There is a need for handling case logic when dealing with satellite data and ground station data. Satellite data can contain missing values (ground station data will not since we are using TMY3 data). In this particular embodiment, ground stations are selected and weighted by distance to the user location. Given that we have selected a user location, there are the following cases:
1. We have at least one station within a threshold distance (e.g. 100 km), and no missing values in satellite data.
2. We have at least one station within threshold distance, and at least one nan (not a number) value in satellite data.
3. We have no stations within threshold distance, and no nan values in satellite data.
4. We have no stations within threshold distance, and at least one nan value in satellite data.
   In case 1, we simply take the mean of the satellite data and the ground station data for outputting DLI values. In case 2, we take the mean of the satellite data (ignoring missing values) and the ground station data for outputting DLI values. In case 3, we only use the satellite data for outputting DLI values. In case 4 we only use the satellite data but fill in missing values using the closest ground stations.

In another embodiment where we are using geographic similarity metrics to select and weight stations, the following cases can appear:

1. We have no missing values in the satellite data.

2. We have at least one missing value in the satellite data.

In case 1, we simply take the average of the geographically similar ground station data and the satellite data. In case 2, we take the average of the geographically similar ground station data and the satellite data while ignoring the missing satellite values.

### EXAMPLES

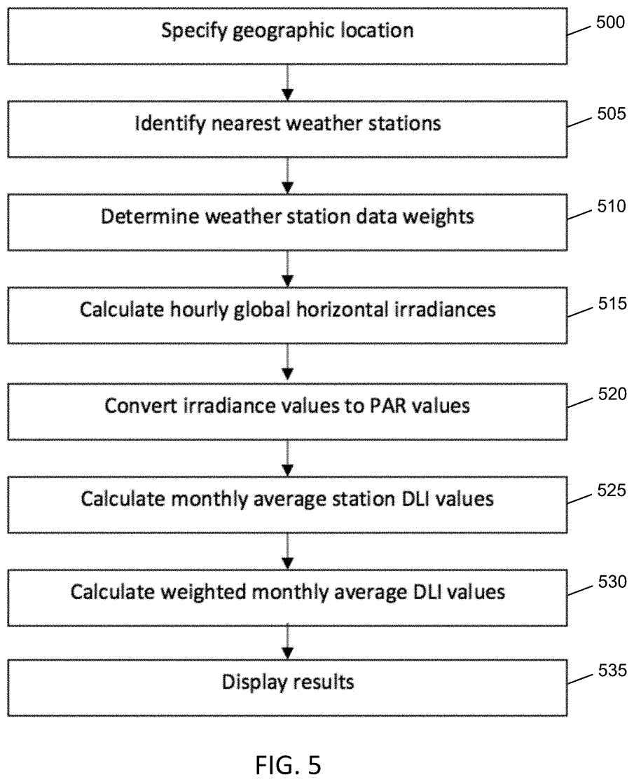

In a first example, the present invention provides monthly average DLI values for a specified geographic location through a web application. Referring to FIG. 5, the process is as follows:

In step 500, the user specifies the latitude and longitude of a location or selects the location on an interactive map via the web application.

In step 505, the nearest weather stations for which historical weather data such as TMY3 weather files is available are identified. For example, the nearest two, three or any higher number of weather stations may be identified.

In step 510, weather station data weights are determined. The weather station weights may be determined based on geographic similarity to the location, or both geographic similarity and proximity to the location.

In step 515, the hourly global horizontal irradiances at each weather station are calculated from the DNI and DHI.

In step 520, the hourly global horizontal irradiance values are converted to PAR values (i.e. PPFD).

In step 525, the monthly average weather station DLI values are calculated from the DNI and DHI data.

In step 530, the weighted monthly average DLI values are calculated.

In step 535, the results are displayed to the user via the web application. The results may then be used to determine whether or not to grow a particular crop at the location. If the DLI requirements for the particular crop are equal, within typical measurement tolerances, to the calculated DLI values, then the location is suitable for growing the crop, at least in terms of the PAR requirement for the crop. If the calculated DLI values are below those that are required for healthy, normal growth of the crop, then the location is not suitable for growing the crop. If the DLI values are above those that are required for normal healthy growth of the crop then the crop may still be grown if the excess PAR does not harm the crop.

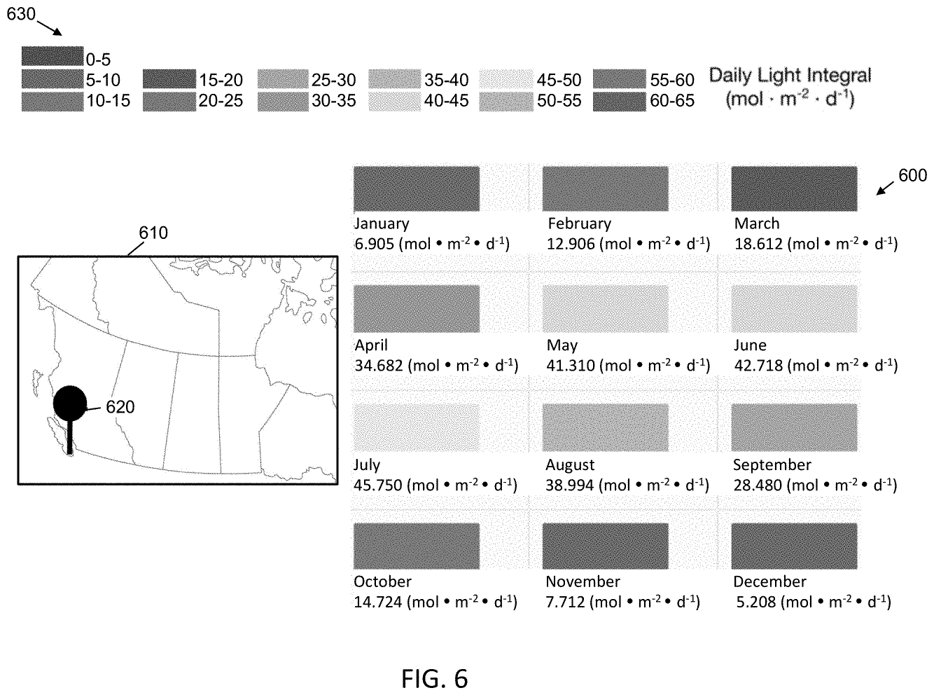

FIG. 6 shows an example of the web application user interface displaying the calculated DLI values, where each month is represented by a color, a DLI value, and text identifying the month. Alongside the grid 600 of monthly DLI values is a map 610 with a pin 620 identifying the geographic location selected by the user. Also shown is a color legend 630 indicating which color corresponds to which range of DLI values.

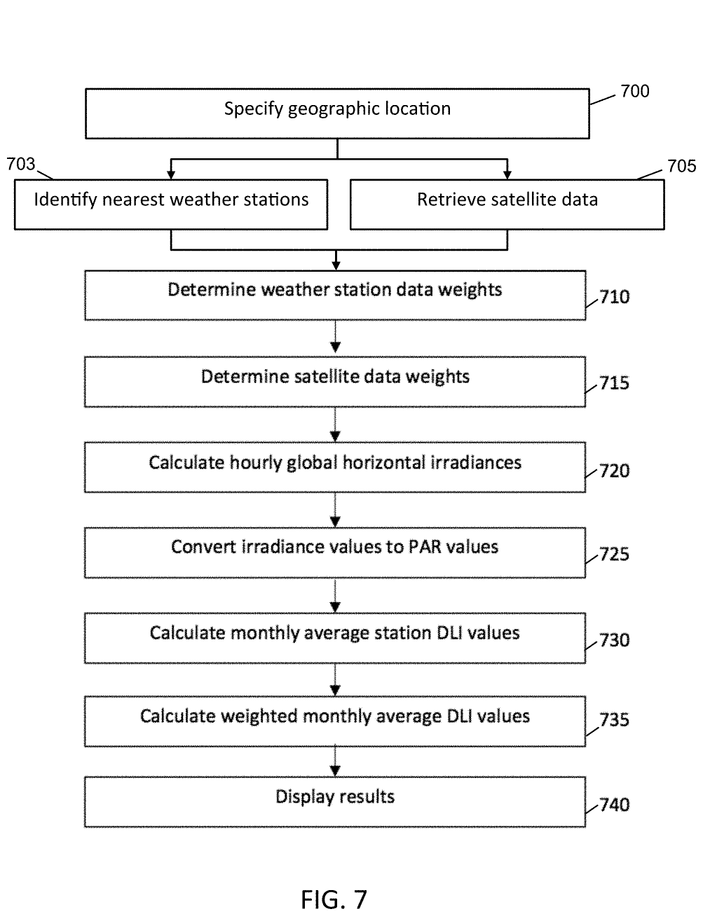

In a second example, which is a variation of the first example, monthly average DLI values are provided through a web application using satellite data as well as ground station data. Referring to FIG. 7, the process is as follows:

In step 700, the user specifies the latitude and longitude of a location or selects the location on an interactive map.

In step 703, the nearest weather stations for which historical weather data such as TMY3 weather files is available are identified. Then satellite data, which contains irradiance data, is retrieved for the user location in step 705.

In step 710, weather station data weights are determined.

In step 715, satellite data weights are determined.

In step 720, the hourly global horizontal irradiances are calculated.

In step 725, the irradiance values are converted to PAR values.

In step 730, the monthly average station DLI values are calculated.

In step 735, the weighted monthly average DLI values are calculated.

In step 740, the results are displayed to the user.

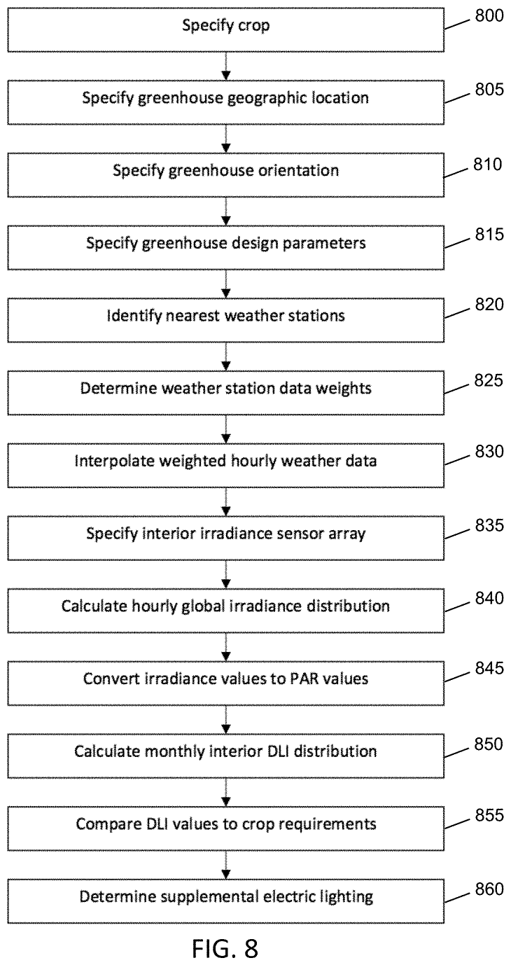

In a third example and referring to FIG. 8, a method of determining whether a proposed or existing greenhouse, polytunnel or other controlled environment in a specified geographic location will provide sufficient monthly DLI for a given crop is as follows:

In step 800, the desired crop is specified or selected from a crop database that includes plant DLI requirements.

In step 805, the geographic location (i.e., latitude and longitude) for the proposed or existing greenhouse, polytunnel or other controlled environment is specified.

In step 810, the orientation of the greenhouse, polytunnel or other controlled environment is specified, for example in degrees clockwise with respect to geodetic north.

In step 815, the design parameters of the controlled environment are specified. For a greenhouse, these may include, but are not limited to, building dimensions, roof style, glazing materials, shading materials, and optional benches. For polytunnels, an agricultural film is specified.

In step 820, the nearest weather stations for which historical weather data such as TMY3 weather files is available are identified.

In step 825, weather station data weights are determined.

In step 830, the hourly average direct normal irradiance, diffuse horizontal irradiance, and optionally dew point temperature are determined.

In step 835, a virtual interior irradiance sensor array for the greenhouse, polytunnel or other controlled environment is specified. In an embodiment, the virtual sensors are positioned as if they were directly above the crop plants.

In step 840, the hourly global horizontal irradiance distribution inside the greenhouse, polytunnel or other controlled environment as determined by the virtual irradiance sensors is calculated in accordance with the Perez All-Weather Sky model (Perez, R., et al. 1993. “All-weather Model for Sky Luminance Distribution—Preliminary Configuration and Validation,” R. Perez et al., Solar Energy 50(3):235-245), and as disclosed in US Patent Application US 2019/0014376.

In step 845, the hourly global horizontal irradiance values (400 nm-2700 nm) inside the controlled environment are converted to PAR values.

In step 850, the monthly interior DLI distribution for the virtual sensor locations are calculated.

In step 855, the calculated, interior DLI values are compared to the DLI requirements of the specified crop.

In step 860, the supplemental electric lighting requirements are determined, if any, and monthly electric energy costs calculated. The supplemental electric lighting, when provided within the controlled environment, will ensure that the total light (i.e. supplemental plus interior DLI) received by the crop meets its requirements for suitable growth. Suitable growth of a crop may be considered to be average, normal healthy growth. The supplemental electric lighting requirements may be displayed on the user interface for the web application, for example.

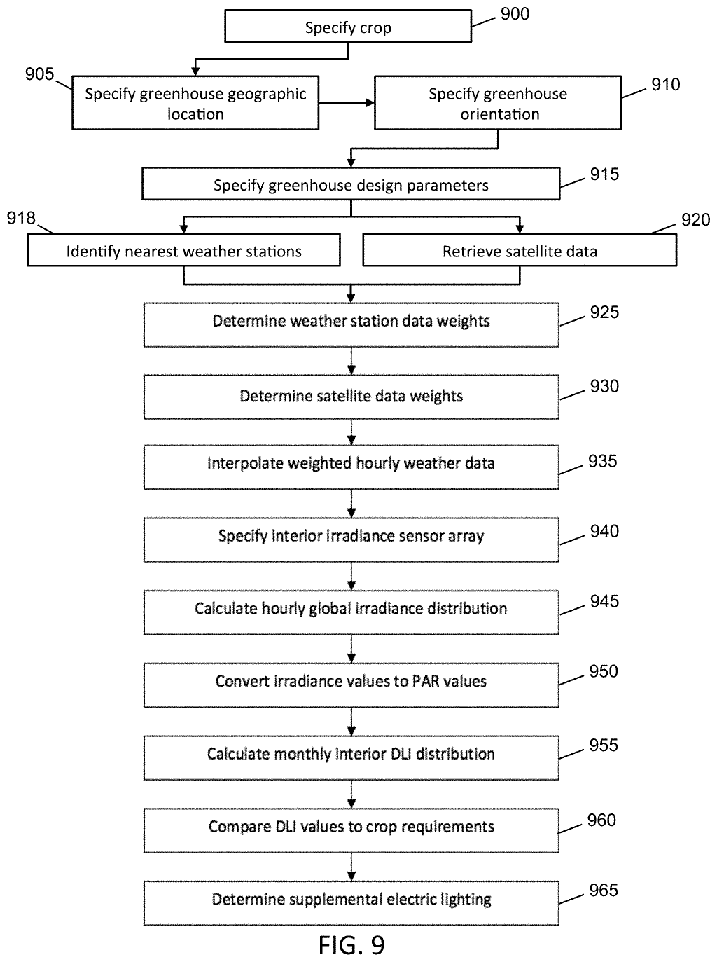

A fourth example, which is a variation of the third example, is where we incorporate satellite data as well as ground station data. Referring to FIG. 9, a method of determining whether a proposed greenhouse or polytunnel in a specified geographic location will provide sufficient monthly DLI for a given crop is as follows:

In step 900, the desired crop is specified or selected from a crop database that includes plant DLI requirements.

In step 905, the geographic location (i.e., latitude and longitude) for the proposed greenhouse or polytunnel is specified.

In step 910, the greenhouse or polytunnel orientation, e.g. in degrees clockwise with respect to geodetic north, is specified.

In step 915, the greenhouse design parameters are specified. These may include, but are not limited to, building dimensions, roof style, glazing materials, shading materials, and optional benches. For polytunnels, an agricultural film is specified.

In step 918, the nearest weather stations for which historical weather data such as TMY3 weather files is available are identified. Then satellite data, which contains irradiance data, is retrieved for the user location in step 920.

In step 925, weather station data weights are determined.

In step 930, satellite data weights are determined.

In step 935, the hourly average direct normal irradiance, diffuse horizontal irradiance, and optionally dew point temperature are determined.

In step 940, a virtual interior irradiance sensor array for the greenhouse or polytunnel is specified. In an embodiment, the virtual sensors are positioned directly above the crop plants.

In step 945, the hourly global horizontal irradiance distribution inside the greenhouse or polytunnel as determined by the virtual irradiance sensors is calculated in accordance with the Perez All-Weather Sky model (Perez, R., et al. 1993. “All-weather Model for Sky Luminance Distribution—Preliminary Configuration and Validation,” R. Perez et al., Solar Energy 50(3):235-245), and as disclosed in US Patent Application US 2019/0014376.

In step 950, the irradiance values (400 nm-2700 nm) are converted to PAR values.

In step 955, the monthly interior DLI distribution for the virtual sensor locations are calculated.

In step 960, the calculated interior DLI values are compared to the DLI requirements of the specified crop.

In step 965, the supplemental electric lighting requirements are determined, and monthly electric energy costs calculated. The supplemental electric lighting, when provided within the controlled environment, will ensure that the total light received by the crop meets its requirements. The supplemental electric lighting requirements may be displayed on the user interface for the web application, for example.

In a fifth example, the direct normal and diffuse horizontal irradiance values exterior to the greenhouse are measured with a digital all-sky camera as disclosed in Gauchet, C., et al. 2012. “Surface Solar Irradiance Estimation with Low-cost Fish-eye Camera,” Proc. Workshop on Remote Sensing Measurements for Renewable Energy (ES1002), Risoe, Denmark.

In an improvement to the disclosed camera system, the present invention performs high-dynamic range (HDR) techniques by capturing a sequence of images with different exposures to accurately determine the sky dome luminance distribution to within ±2.5 degrees of the solar position. This is commonly used to demark the region of direct solar irradiance as measured by meteorological pyrheliometers as prescribed in (WMO. 2017. WMO Guide to Meteorological Instruments and Methods of Observation, Chapter 7: Measurement of Radiation).

The measured direct normal and diffuse horizontal irradiance values are measured at subhourly intervals, for example every five minutes, and the hourly average values are stored in a database. These values may then be used to calculate monthly average DLI values for the geographic location, which may then be used to predict monthly average DLI values at nearby locations that are closer than the nearest weather stations. By making such measurements with the camera, the location of the greenhouse effectively becomes another weather station that may be used by embodiments of the present invention for calculating the DLI values of another geographic location.

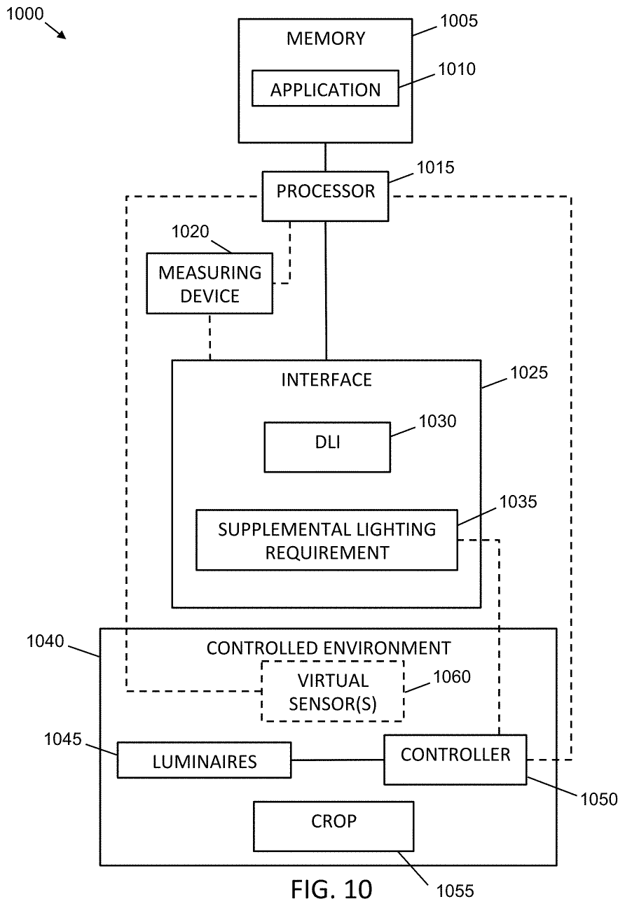

Referring to FIG. 10, an exemplary system 1000 is shown for the calculation of DLI for a specified geographic location. The system 1000 includes a non-transient computer readable memory 1005 storing computer readable instructions in the form of an application 1010, which, when executed by the processor 1015 provide one or more of the functions of the system. A measuring device 1020 for measuring the value of a parameter of the geographic location is either connected to the processor 1015 or its output is input into the processor via a user interface 1025. The measuring device may be a thermometer or humidity meter, for example. The processor 1015 controls the interface 1025 so that it displays the calculated DLI 1030 for the specified geographic location. The interface 1025 may also display the supplemental lighting requirement 1035 for a particular crop, for which the DLI required for optimal or satisfactory growth is known, and for which the calculated DLI 1030 is insufficient for suitable growth. The system may include a controlled environment 1040 in which luminaires 1045 are installed for providing supplemental electric lighting. The controller 1050 controls the luminaires to provide the supplemental electric lighting as determined by the system in relation to a crop 1055 that is being grown in the controlled environment 1040. The controller 1050 may be connected to the processor 1015 in order to receive an input that defines the supplemental electric lighting 1035, or the amount of supplemental lighting requirement may be otherwise input into the controller 1050. The controller 1050 may include or be connected to irradiance sensors in the controlled environment 1040, and may adjust the amount of supplemental electric lighting based on the natural daylight that is entering the controlled environment. The virtual sensor(s) 1060 that are shown in the controlled environment 1040 are used by the processor 1015 to determine the supplemental lighting requirement 1035 for the crop 1055.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs one or more of the steps in the flowcharts, whether they are explicitly described as being executed by the processor or whether the execution thereby is implicit by being described as performed by a module. The processor, if comprised of multiple processors, may be located together or geographically separate from each other. The term includes virtual processors and machine instances as in cloud computing or local virtualization, which are ultimately grounded in physical processors.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification is to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

The embodiments and examples of the invention may be varied in many ways. For example, features from different examples may be included in another embodiment. Steps in the flowcharts may be performed in a different order, additional steps may be added and steps may be removed. Such variations are not to be regarded as a departure from the scope of the invention, and all such modifications as would be obvious to one skilled in the art are intended to be included within the scope of the claims.

We claim:

1. A method for calculating a daily light integral (DLI) in a geographic location comprising the steps of:
determining a value of a parameter of the geographic location;
determining, for each of multiple weather stations, a further value for a corresponding parameter of a location of the weather station;
calculating a geographic similarity of each of the multiple weather stations to the geographic location using the value and the further values;
weighting DLI values for each of the multiple weather stations using the geographic similarities;
calculating DLI values for the geographic location using the weighted DLI values; and
displaying the calculated DLI values for the geographic location.

2. The method of claim 1, comprising growing, at the geographic location, a crop for which the calculated DLI values are suitable.

3. The method of claim 1, wherein determining the value of the parameter comprises measuring the parameter.

4. The method of claim 1, comprising:
determining a latitude and longitude of the geographic location; and
selecting the multiple weather stations from a group of weather stations, wherein the multiple weather stations are those that are nearest to the geographic location.

5. The method of claim 4 comprising:
training a neural network using geographic similarities between pairs of weather stations selected from the group of weather stations;
wherein calculating the geometric similarity of each of the multiple weather stations to the geographic location comprises using a prediction that is output by the neural network.

6. The method of claim 1, wherein the DLI values for each of the multiple weather stations are determined by:
calculating hourly global horizontal irradiances (GHIs) from historical weather data from the weather station, the historical weather data including direct normal and diffuse horizontal irradiance values;
converting the GHIs to photosynthetic photon flux density (PPFD) values;
using the PPFD values to calculate the DLI values.

7. The method of claim 6, wherein the DLI values are weighted by weighting the GHIs.

8. The method of claim 1, wherein the displayed DLI values are monthly average DLI values.

9. The method of claim 1 comprising:
specifying one or more parameters of a controlled environment at the geographic location;
specifying a virtual irradiance sensor array for the controlled environment; and
using the parameters of the controlled environment and a location of the virtual irradiance sensor array when calculating DLI values for the geographic location, wherein the calculated DLI values are for the location corresponding to the virtual irradiance sensor array.

10. The method of claim 9 comprising:
specifying a crop with known DLI requirements; and
comparing the calculated DLI values with the known DLI requirements,

11. The method of claim 10, comprising calculating supplemental electric lighting requirements for the specified crop based on the comparison.

12. The method of claim 11, comprising growing the crop in the controlled environment while providing the supplemental electric lighting.

13. The method of claim 9 wherein the one or more parameters of the controlled environment include an orientation of the controlled environment and a design parameter of the controlled environment.

14. The method of claim 1, comprising:
retrieving shortwave irradiance measurements made by satellites;
calculating hourly global horizontal irradiances (GHIs) from the shortwave irradiance measurements;
weighting the hourly GHIs from the shortwave irradiance measurements; and
using the weighted hourly GHIs from the shortwave irradiance measurements when calculating the DLI values.

15. The method of claim 14 wherein the weights of the hourly GHIs from the shortwave irradiance measurements are based on geographic similarity.

16. The method of claim 6 comprising:
combining the hourly GHIs from the weather stations with the hourly GHIs from satellite data; and
using the combined GHIs to train a neural network that predicts the DLI values.

17. The method of claim 1, wherein the DLI values for one of the multiple weather stations are obtained by:
using a digital all-sky camera to capture a subhourly sequence of images of the sky with different exposures;
calculating, from the images, hourly direct normal and diffuse horizontal irradiance values; and
using the hourly direct normal and diffuse horizontal irradiance values to calculate the DLI values for said one of the multiple weather stations.

18. A system for calculating a daily light integral (DLI) in a geographic location comprising:
a display;
a processor; and
a computer readable memory storing computer readable instructions, which, when executed by the processor cause the processor to:
receive a value of a parameter of the geographic location;
determine, for each of multiple weather stations, a further value for a corresponding parameter of a location of the weather station;
calculate a geographic similarity of each of the multiple weather stations to the geographic location using the value and the further values;
weight DLI values for each of the multiple weather stations using the geographic similarities;
calculate DLI values for the geographic location using the weighted DLI values; and
output the calculated DLI values for the geographic location on the display.

19. The system of claim 18 comprising a controlled environment at the geographic location, wherein the processor is configured to:
receive a value of one or more parameters of the controlled environment;
specify a virtual irradiance sensor array for the controlled environment; and
use the one or more values of the one or more parameters of the controlled environment and a location of the virtual irradiance sensor array when calculating DLI values for the geographic location, wherein the calculated DLI values are for the location corresponding to the virtual irradiance sensor array.

20. The system of claim 19 comprising:
one or more luminaires in the controlled environment; and
a controller that controls the luminaires to provide supplemental electric lighting to a crop that is grown in the controlled environment;
wherein the supplemental electric lighting added to the calculated DLI values provides suitable photosynthetically active radiation for growth of a crop in the controlled environment.
